(19) United States
(12) Patent Application Publication
(10) Pub. No.: US 2026/0322126 A1
(43) Pub. Date: Oct. 15, 2026

(54) TRANSFORMER LOAD MONITORING AND CONTROL

(71) Applicant: Landis+Gyr Technology, Inc., Alpharetta, GA (US)

(72) Inventor: Jeff SCHEB, Greensboro, NC (US)

(21) Appl. No.: 19/483,688

(22) PCT Filed: Jun. 7, 2024
(86) PCT No.: PCT/US2024/032976

§ 371 Date: Nov. 12, 2025

(30) Foreign Application Priority Data
Jun. 9, 2023 (GB) 2308632.5

(51) Int. Cl. H02J 3/14; H02J 13/12; H02J 13/16; H02J 13/182; H02J 103/35; H02J 105/52

(52) U.S. Cl. CPC H02J 3/14; H02J 13/12; H02J 13/16; H02J 13/182; H02J 2103/35; H02J 2105/52

(57) ABSTRACT

A method of controlling a network of devices in a power distribution network to prevent power overload, the method comprises: setting an aggregate power threshold based on a max rating of a transformer connected to the devices in the network; for each device in the network, setting an individual power threshold based on the aggregate threshold and the number of devices in the network; in response to determining that a first device in the network has a power exceeding its individual power threshold, querying other devices in the network to determine a combined power usage of the network; and when the combined power usage exceeds the aggregate power threshold, controlling one or more devices in the network to reduce the combined power usage.

### BACKGROUND

Distribution transformers in power distribution networks supplying power to end users experience varying loads and may overheat under a prolonged power surge. A transformer with a higher current rating may be installed to service a network with known high power consumption, for example due to a large number of end users. However, the overall consumption may change over time, for example due to an increased number of electric vehicles (EVs) connected to and charged on the network, which can lead to transformer overload.

Hence, improved systems and methods for monitoring and controlling the power load are needed.

### SUMMARY

Aspects of the invention provide a method and system of controlling a network of devices (typically electric meters) to prevent power overload. In particular, a primary device is used to monitor the combined power usage, and, if necessary, initiate a power conservation event.

According to a first aspect, there is provided a method of controlling a network of devices in a power distribution network to prevent power overload, the method comprises:
setting an aggregate power threshold based on a max rating of a transformer connected to the devices in the network;
for each device in the network, setting an individual power threshold based on the aggregate threshold and the number of devices in the network;
in response to determining that a first device in the network has a power exceeding its individual power threshold, querying other devices in the network to determine a combined power usage of the network; and
when the combined power usage exceeds the aggregate power threshold, controlling one or more devices in the network to reduce the combined power usage.

The power can be expressed in volt-ampere (typically kVA). The max rating, the thresholds and the usage may be equivalently expressed as a value of energy per unit time or as a value of (electric) current. The aggregate threshold is typically equal to the sum of individual power thresholds of the devices in the network.

The step of controlling the one or more devices comprises sending a stop command to at least one of the one or more devices to cause those devices to stop drawing power from the transformer. In response to receiving the stop command, the first device can disable one or more systems of the end user that draw power from the transformer to thereby decrease the load on the transformer.

The method may further comprise setting a safe level of combined power usage. In response to determining that the combined power usage is below the safe level, a start command can be sent to the one or more devices to cause those devices to start drawing power from the transformer again. The safe level may be at or below the aggregate power threshold. This allows normal operation to resume once the load on the transformer is at or below the safe level.

The method may further comprise setting a reporting frequency of the devices. For example, in addition to the exception-based reporting, when the usage exceeds the individual threshold, the devices can be configured to report their usage at set intervals. The method may further comprise, in response to determining that the first device in the network has a power exceeding its individual power threshold, configuring one or more devices in the network to increase the reporting frequency of those devices.

The method can comprise dynamically updating the individual power threshold of the first device. For example, the max rating of the transformer can change (e.g. due to weather or transformer age), which causes a change in the calculated aggregate power threshold and in turn also the individual power threshold. In an embodiment, dynamically updating comprises, in response to determining that the combined power usage does not exceed the aggregate power threshold, setting a higher individual power threshold for the first device. Hence, one or more (but not all) devices can be allowed to exceed their individual power thresholds when the combined usage remains below the aggregate threshold. However, in order to continue to monitor the usage, a new (higher) threshold can be set for these devices, so that they continue to report if the usage increases. In an embodiment, dynamically updating comprises, in response to determining that the combined power usage does not exceed the aggregate power threshold, setting successively higher individual power thresholds for the first device with decreasing increments.

According to a second aspect there is provided a system for controlling a network of devices in a power distribution network to prevent power overload, the system comprises:
a head-end system configured to communicate with a primary device of the network and to store a max rating of a transformer connected to the devices in the network;
a primary device of the network of devices configured to:
   obtain an aggregate power threshold based on the max rating of the transformer;
   set an individual power threshold based on the aggregate threshold and based on the number of devices in the network;
   in response to determining that a first device in the network has a power exceeding its individual power threshold, querying other devices in the network to determine a combined power usage of the network; and
   when the combined power usage exceeds the aggregate power threshold, control one or more devices in the network to reduce the combined power usage.

The aggregate threshold is typically equal to the sum of individual power thresholds of the devices in the network.

The primary device can be configured reduce the combined power usage by sending a stop command to at least one of the one or more devices to cause those devices to stop drawing power from the transformer.

The primary device can further be configured to set a safe level of combined power usage, and, in response to determining that the combined power usage is below the safe level, send a start command to the one or more devices to cause those devices to start drawing power from the transformer again.

The primary device can be further configured to set a reporting frequency of the devices in the network. The primary device can be configured to, in response to determining that the first device in the network has a power exceeding its individual power threshold, configure one or more devices in the network to increase the reporting frequency of the devices.

The primary device can be further configured to dynamically update the individual power threshold of the first device. For example, the max rating of the transformer can change (e.g. due to weather or transformer age), which causes a change in the calculated aggregate power threshold and in turn also the individual power threshold. In an embodiment, dynamically updating comprises, in response to determining that the combined power usage does not exceed the aggregate power threshold, setting a higher individual power threshold for the first device. Hence, one or more (but not all) devices can be allowed to exceed their individual power thresholds when the combined usage remains below the aggregate threshold. However, in order to continue to monitor the usage, a new (higher) threshold can be set for these devices, so that they continue to report if the usage increases. In an embodiment, dynamically updating comprises, in response to determining that the combined power usage does not exceed the aggregate power threshold, setting successively higher individual power thresholds for the first device with decreasing increments.

The system can be configured to perform the method of the first aspect.

According to a third aspect there is provided an electric meter for controlling a network of electric meters in a power distribution network, wherein the electric meter comprises:
a measuring unit for measuring power usage of an associated end consumer;
a communication unit for communicating with the devices in the network of devices;
a memory; and
a processor configured to
   obtain an aggregate power threshold based on the max rating of a transformer connected to the network of electric meters;
   set an individual power threshold based on the aggregate threshold and based on the number of electric meters in the network;
   in response to determining that a first electric meter in the network has a power exceeding its individual power threshold, querying other electric meters in the network to determine a combined power usage of the network; and
   when the combined power usage exceeds the aggregate power threshold, control one or more of the electric meters in the network to reduce the combined power usage

The electric meter may be the primary device of the system of the second aspect.

Specific embodiments of the invention will now be described with reference to the accompanying drawings.

### BRIEF DESCRIPTION OF DRAWINGS

FIG. 1 shows a schematic diagram of a power distribution network;

FIG. 2 shows a schematic diagram of a part of a power distribution network;

FIG. 3 shows a flow diagram of a method in an electric meter;

FIG. 4 shows a flow diagram of a method in an electric meter; and

FIG. 5 shows a schematic diagram of an electric meter.

### DETAILED DESCRIPTION

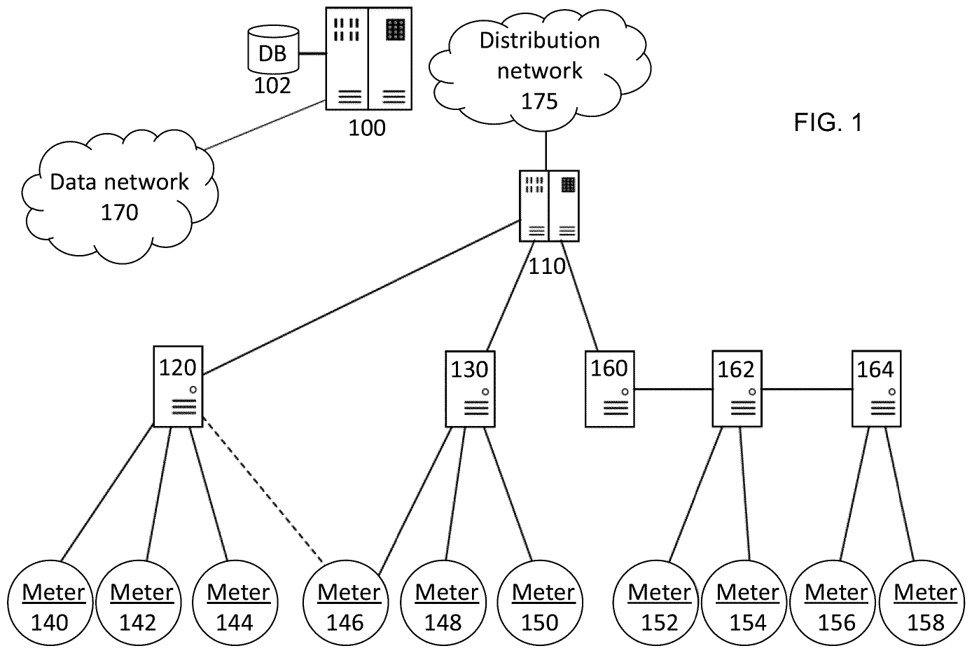

FIG. 1 shows a portion of an exemplary distribution network. A substation 110 is connected to a distribution network 175, such as a power grid, and is in turn connected to transformers 120, 130, 160, 162, 164. Meters 140, 142, 144, 146, 148, 150 are connected to transformers 120 and 130.

The meters can communicate with a head-end system 100. In one example, multiple meters are connected via a wireless mesh network. A device in the network, such as a collector or PAN coordinator, may facilitate the communication of data from the wireless mesh network to the head-end system 100 via one or more networks 170. Other types of communication between the meters and the head-end system 100 are also possible including, but not limited to, cellular communications and power line communications.

A meter may communicate consumption information to the head-end system 100, as well as other information measured or detected by the meter. In some examples, the meter communicates voltage information to the head-end system. The voltage information may be associated with a time interval, such as a 15 minute interval. The meter may provide voltage information for multiple time intervals over multiple days. The head-end system may maintain voltage information provided by the meters in a database 102 or other data storage facility.

The head-end system may also maintain other types of information about the meters and other devices in the distribution network. For example, GIS information describing the location of a meter or a transformer may be maintained. In some networks, the head-end system also receives data related to the operation of a device other than a meter, such as a substation, a transformer, or other device.

The head-end 100 system may maintain connectivity information for the meters 140, 142, 144, 146, 148, 150 and the transformers 120, 130 in a database 102. The information may be initially provided upon installation or deployment of the meters and transformers or may be obtained from a legacy system.

The head-end system 100 may also maintain power ratings and thresholds for devices in the distribution network. For example, the head-end system 100 may maintain a max power/current rating of the distribution transformers and an associated aggregate power threshold (which may be the same or lower than the power rating), which sets a safe maximum combined consumption of end users supplied by the distribution transformer. The head-end system 100 can use the aggregate power threshold to calculate and set individual power thresholds. For example, in one embodiment the individual threshold is calculated by dividing the aggregate power threshold by the number of end users supplied by the distribution transformer. In other embodiments, the individual power thresholds may be different between different users. The head-end system can be configured to maintain and update the individual power thresholds based on changes to the network (e.g. due to the addition of another end user connected to the distribution transformer).

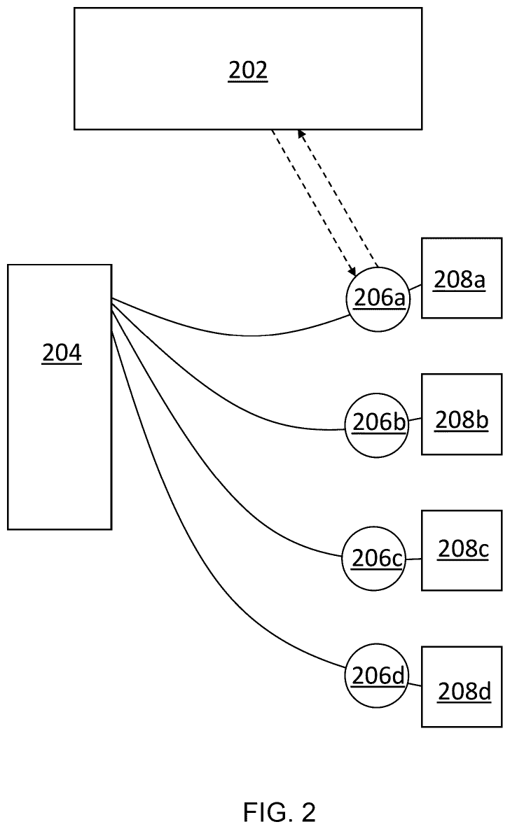

FIG. 2 shows a schematic diagram of a part of a distribution system 200 comprising a head-end system 202, a distribution transformer 204, and a plurality of electric meters 206a-d connected to the distribution transformer 204. The plurality of meters 206a-d connected to the same distribution transformer 204 may be referred to as a “family” of meters. The distribution network 200 generally comprises a plurality of families connected to respective distribution transformers 204. Each electric meter 206a-d may be associated with a respective end user 208a-d and configured to monitor the usage of that end user 208a-d. An end user 208 may typically be represented by house/home comprising a number of appliances drawing power from the distribution network (e.g. a HVAC system and EV chargers).

The plurality of electric meters 206a-d comprises a primary meter 206a for communicating with the head-end system 202. For example, the other “secondary” meters 206b-d can be configured to communicate with the primary meter 206a, which is configured to forward the communications to the head-end system 202. Similarly, the primary meter 206a may be configured to route downlink communications from the head-end system 202 to individual meters 206. The primary and secondary meters may comprise identical hardware and/or software, and be only distinguished by e.g. a toggle value or flag in the configuration settings of the meter 206, which can be set by the head-end system 202 or on installation to select the primary meter 206a. This network configuration, having a primary meter 206a for communicating with the head-end system, can reduce the amount of traffic on the network (typically a so called field area network, FAN), which has a limited bandwidth.

In an embodiment, the head-end system 202 stores or can otherwise access the max rating of the local transformer 204, based on which it determines an individual threshold for each meter 206 connected to that transformer 204 (i.e. each meter 206 in that family). The individual threshold can be set such that if all meters 206a-d in the family were to reach that level of real-time power consumption, the aggregate load off that transformer would be at or below its max rating. Hence, the aggregate threshold, being the sum of the individual thresholds, may be set to a value at or below the max rating of the distribution transformer 204. The max rating may not be static but could be dynamically calculated, based on one or more parameters, such as daily temperature variations. That is the max rating can be a function of one or more determined or predicted parameters. For example, if a determined or predicted temperature value is above a pre-set temperature threshold value, then the max rating can be decreased. To reduce network traffic, the max rating may be calculated at set intervals rather than continuously. Alternatively, the max rating may be calculated continuously while the aggregate threshold is updated based on the max rating at set intervals. Once a new aggregate threshold is determined, new individual thresholds are transmitted to the electric meters 206a-d. The head-end system 202 can provide the individual threshold to all meters 206a-d in the family, while the primary meter 206a can additionally also be provided with the aggregate threshold.

Each meter 206 in the family can be configured to continuously monitor its real-time consumption (i.e. the real-time usage of the end user 208 associated with that meter 206). If the consumption reaches the individual threshold level, the meter 206 can send an alert (e.g. over the utility FAN) to the primary meter 206a in the same family. In response, the primary meter 206a can solicit usage checks from other meters 206b-din the family to determine the real-time aggregate load under the transformer 204.

When the aggregate load is below the aggregate threshold the primary meter 206a can be configured to take no action. When another meter 206 in the family reaches its individual threshold, it similarly notifies the primary meter 206a, which in response again solicits a usage check from other meters 206 in the family. If the real-time load of a meter 206 that flagged usage above the individual threshold continues to increase, it can be configured to continue to notify the primary meter 206a for every X% increase beyond the initially set individual threshold (where X can be configurable). For example, X may be between 5% and 20%. In on embodiment, X can be set to decrease as the consumption gets further away from the initially set individual threshold. For example, X may be initially set to 10, and then when the consumption reaches 110% of the individual threshold, the meter 206 reports to the primary meter 206a and X is set to 5, so that the next report is sent when the consumption increases by just another 5%. Similarly, if the consumption measured by a meter 206 drops below the threshold, it alerts the primary meter 206a. In this way, the primary meter 206a is made aware as risk of nearing the transformer max rating increases or decreases within the family beyond a certain point.

When the aggregate usage across the family reaches the pre-determined aggregate threshold, the primary meter 206a can be configured to alert the head-end system 202 and/or to instruct one or more meters 206 in the family to initiate one or more emergency load conservation events. Emergency load conservation events may include direct control of EV chargers, HVAC systems, or hot water heaters, for example, using a local Wi-Fi connection on the electric meter 206 to communicate with these devices in the home of the end user 208. This can allow for the autonomous shedding of load in order to protect the transformer 202 from exceeding its max rating and overheating. For example, in one embodiment, when the primary meter 206a determines that the aggregate threshold has been reached or exceeded, it sends a report to the head-end 202 system and waits for further instructions/commands from the head-end system 202 before taking further action. The head-end system 202 may send a command to the primary meter 206a, causing the primary meter 206a to command one or more of the meters 206 in the family to initiate a load conservation event. In another embodiment, the primary meter 206a may be configured to automatically command one or more other meters 206 in the family to initiate such a load conservation event without waiting for the head-end system 202 to provide instructions. This can allow the aggregate consumption to be reduced quickly as it approaches the max rating of the transformer 202 to thereby reduce the risk of transformer failure.

The primary meter 206a can be further configured to determine when the aggregate consumption has decreased below a safe level, which may be equal to the aggregate threshold or to a consumption level below that of the aggregate threshold by a predefined amount. For example, the safe level may be set to be 90% of the aggregate threshold. In response to determining that the aggregate consumption has dropped to the safe level, the primary meter 206a can be configured to end the load conservation event and cause all meters 206a-d in the family to revert to the original operation mode. The primary meter 206a can be configured to command all meters 206a-d in the family to resume a normal operating state in which they continue to monitor real-time consumption and report to the primary meter 206a once the individual threshold is exceeded.

By only alerting the primary meter 206a when the meter's individual threshold is reached, excessive traffic over the network can be avoided. This can be advantageous as the network is typically a FAN, which is a constrained network with limited bandwidth. If all meters 206a-d in a family were to continuously report their real-time usage data to the head-end system 202, the network may not have adequate bandwidth. Instead, each meter 206 operates as described herein on a “report by exception” basis, and wherein when a meter experiences high usage (above the individual threshold), the primary meter 206a begins polling other meters 206 in the family to determine the aggregate consumption. If the aggregate consumption increases and other meters 206 report high usage, the primary meter 206a may poll more frequently in order to more closely monitor the situation. This combination of unsolicited alarms and dynamic polling can be used to minimize network traffic while ensuring near real-time recognition of a transformer overload condition.

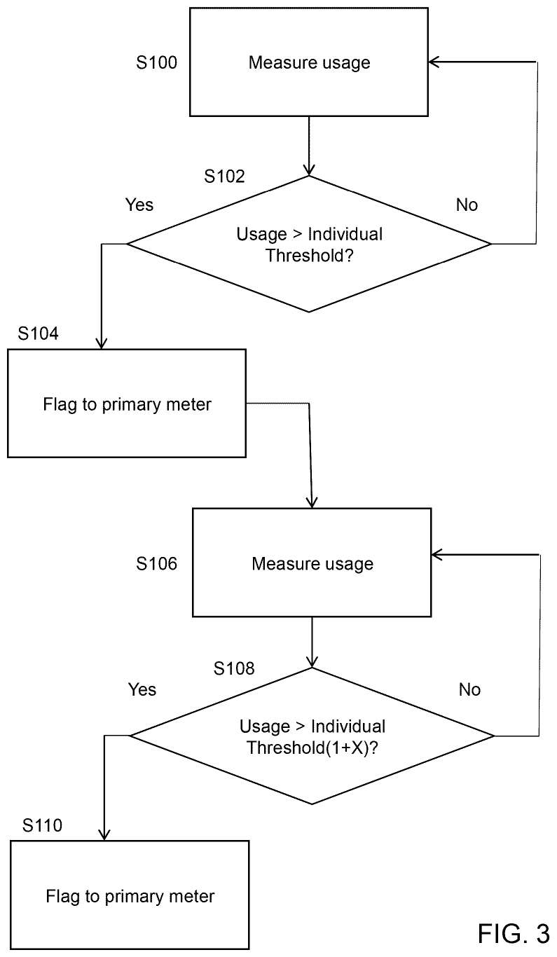

FIG. 3 shows a flow diagram illustrating some steps of a method performed by an electric meter as a part of controlling the power distribution to an end consumer. The method comprises a first step of measuring power usage/consumption S100. The measured usage is compared to the meter's individual threshold S102. If the usage does not exceed the individual threshold, then the meter continues to measure the usage S100. If the usage exceeds the threshold, then the meter flags this to the primary meter S104. For example, the meter can be configured to send a message to the primary meter, wherein the message may comprise the measured real-time usage and an identifier for identifying the meter in the family. After flagging the high usage, the meter continues to measure the usage S106. The meter determines if the usage exceeds a new threshold, being X% higher than the individual threshold S108. When the new threshold is exceeded, the meter flags this to the primary meter S110. If the new threshold is not exceeded, the meter continues to measure the usage S106.

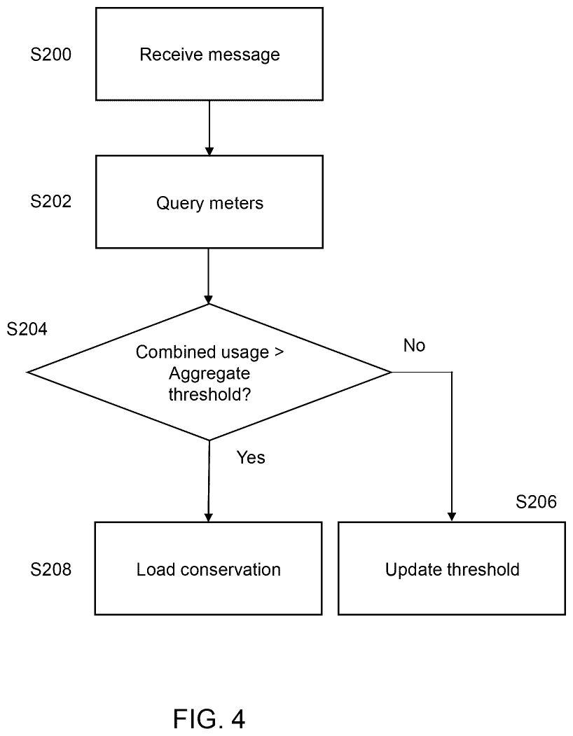

FIG. 4 shows a flow diagram illustrating the steps of a method performed by the primary meter in a network of electric meters. The primary meter receives a message from a secondary meter in the network indicating high usage S200. In response, the primary meter queries the other meters to determine a combined usage S202. The primary meter determines if the combined usage exceeds an aggregate threshold based on the max rating of the transformer connected to the network of meters S204. If the combined usage is below the aggregate threshold, then the primary meter updates the threshold for reporting high usage of the secondary meter S206. In addition, the primary meter may set a reporting frequency of all secondary meters in the network to monitor the combined usage at regular intervals. If the combined usage exceeds the aggregate threshold, then the primary meter imitates a load conservation event S208. This may comprise automatically sending a stop command to some or all the secondary meters in the network to cause them to disable specific systems (typically power intensive systems such as EV chargers, HVAC systems and/or water heaters) that are connected to the secondary meter. The primary meter will also typically send a message to the head-end system to inform the head-end system of the high combined usage and the initiation of the load conservation event.

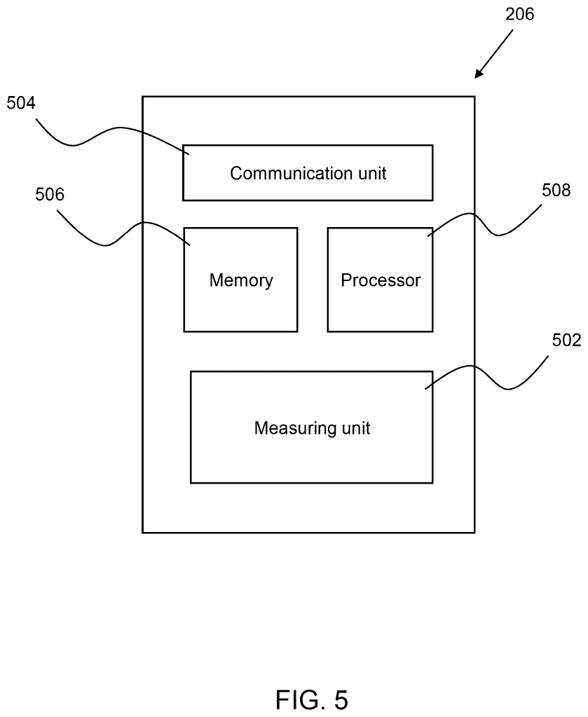

FIG. 5 shows a schematic block diagram of an electric meter 206. The electric meter may be one of the meters illustrated in FIG. 1 or 2. The electric meter 206 comprises a measuring unit 502 for measuring the usage/consumption of an associated end user. The meter 206 may comprise a display (not shown) for showing the current and/or historic usage. The electric meter 206 comprises a communication unit 504 suitable for communicating with other electric meters in the same family and with the head-end system. The communication unit 504 may comprise a wireless transmitter and receiver for transmitting the measured usage and for receiving commands respectively. The meter 206 comprises a memory 506 for storing information such as the individual threshold and the identity (e.g. address) of the primary meter in the family. The meter 206 comprises a processor 508 configured to compare the measured usage from the measuring unit 502 with the individual threshold stored in memory 506, and, when the usage is greater than the individual threshold, send a message indicating high usage to the primary meter. The message may include the measured usage. If the meter 206 is the primary meter, then the processor 508 is configured to query the other (secondary) meters in the family via the communication unit 504 to cause them to report their respective measured usage to the primary meter. The primary meter receives the usage from the secondary meters via the communication unit 504. The processor 508 is configured to calculate a combined usage from the individual usages received and to compare the combined usage with an aggregate threshold stored in the memory 506. The meter 206, when being the primary meter, may be configured to receive the aggregate threshold from the head-end system via the communication unit 504. Alternatively, the meter 206 may be configured to receive a max rating of the transformer from the head-end system via the communication unit 504, wherein the processor is configured to calculate the aggregate threshold and the individual threshold and to store the aggregate threshold in the memory 506 and to send the individual threshold to the secondary meters in the family.

While specific embodiment have been described above, the skilled person will appreciate that further embodiments falling within the scope of the claims are possible. The features of any one embodiment may be suitably combined with those of one or more other embodiments.

1. A method of controlling a network of devices in a power distribution network to prevent power overload, the method comprising:
setting an aggregate power threshold based on a max rating of a transformer connected to the devices in the network;
for each device in the network, setting an individual power threshold based on the aggregate threshold and the number of devices in the network;
in response to determining that a first device in the network has a power exceeding its individual power threshold, querying other devices in the network to determine a combined power usage of the network; and
when the combined power usage exceeds the aggregate power threshold, controlling one or more devices in the network to reduce the combined power usage.

2. A method according to claim 1, wherein the step of controlling the one or more devices comprises sending a stop command to at least one of the one or more devices to cause those devices to stop drawing power from the transformer.

3. A method according to claim 2, further comprising setting a safe level of combined power usage, and in response to determining that the combined power usage is below the safe level sending a start command to the one or more devices to cause those devices to start drawing power from the transformer again.

4. A method according to claim 1, further comprising setting a reporting frequency of the devices.

5. A method according to claim 4, further comprising, in response to determining that the first device in the network has a power exceeding its individual power threshold, configuring one or more devices in the network to increase the reporting frequency of the devices.

6. A method according to claim 1, further comprising dynamically updating the individual power threshold of the first device.

7. A method according to claim 6, wherein dynamically updating comprises, in response to determining that the combined power usage does not exceed the aggregate power threshold, setting a higher individual power threshold for the first device.

8. A method according to claim 6, wherein dynamically updating comprises, in response to determining that the combined power usage does not exceed the aggregate power threshold, setting successively higher individual power thresholds for the first device with decreasing increments.

9. A system for controlling a network of devices in a power distribution network to prevent power overload, the system comprising:
a head-end system configured to communicate with a primary device of the network and to store a max rating of a transformer connected to the devices in the network;
a primary device of the network of devices configured to:
obtain an aggregate power threshold based on the max rating of the transformer;
set an individual power threshold based on the aggregate threshold and based on the number of devices in the network;
in response to determining that a first device in the network has a power exceeding its individual power threshold, querying other devices in the network to determine a combined power usage of the network; and
when the combined power usage exceeds the aggregate power threshold, control one or more devices in the network to reduce the combined power usage.

10. A system according to claim 9, wherein the primary device is configured reduce the combined power usage by sending a stop command to at least one of the one or more devices to cause those devices to stop drawing power from the transformer.

11. A system according to claim 10, wherein the primary device is further configured to set a safe level of combined power usage, and, in response to determining that the combined power usage is below the safe level, send a start command to the one or more devices to cause those devices to start drawing power from the transformer again.

12. A system according to claim 9, wherein the primary device is further configured to set a reporting frequency of the devices.

13. A system according to claim 12, wherein the primary device is further configured to, in response to determining that the first device in the network has a power exceeding its individual power threshold, configure one or more devices in the network to increase the reporting frequency of the devices.

14. A system according to claim 9, wherein the primary device is further configured to dynamically update the individual power threshold of the first device.

15. An electric meter for controlling a network of electric meters in a power distribution network, the electric meter comprising:
a measuring unit for measuring power usage of an associated end consumer;
a communication unit for communicating with the devices in the network of devices;
a memory; and
a processor configured to
obtain an aggregate power threshold based on the max rating of a transformer connected to the network of electric meters;
set an individual power threshold based on the aggregate threshold and based on the number of electric meters in the network;
in response to determining that a first electric meter in the network has a power exceeding its individual power threshold, querying other electric meters in the network to determine a combined power usage of the network; and
when the combined power usage exceeds the aggregate power threshold, control one or more of the electric meters in the network to reduce the combined power usage.
